(19) United States
(12) Patent Application Publication
(10) Pub. No.: US 2009/0094018 A1
(43) Pub. Date: Apr. 9, 2009

(54) Flexible Phrasebook

(75) Inventors: Rile Hu, Beijing (CN); Yue Zhong Tang, Beijing (CN); Xia Wang, Beijing (CN); Juha Iso-Sipila, Tampere (FI)

Correspondence Address: PERMAN & GREEN, 425 POST ROAD, FAIRFIELD, CT, 06824, US

(73) Assignee: Nokia Corporation, Espoo (FI)

(21) Appl. No.: 11/868,172

(22) Filed: Oct. 8, 2007

(51) Int. Cl. G06F 17/28; G10L 21/06

(52) U.S. Cl. 704/4; 704/270; 704/277; 704/E15.022; 704/E15.04

(57) ABSTRACT

A method and a device including a display, a memory, a processor and a keypad, wherein the device is configured to identify a flexible phrase having at least one empty field, receive input corresponding to at least one field value and insert said at least one field value into said at least one empty field thereby completing the flexible phrase.

### FIELD

The present application relates to a device and a method adapted for translation. In particular the application relates to a device and a method adapted for translation using a flexible phrase.

### BACKGROUND

Many contemporary devices offer translation capabilities such as computers, portable and stationary, personal digital assistants, PDAs and mobile communication terminals. This can be done in many ways like for example word by word, sentence by sentence or paragraph by paragraph using intelligent semantic analysis or phrase by phrase. These all suffer from disadvantages. Word by word translation often lose track of the semantic meaning and end up making little or no sense. Translation using intelligent semantic analysis is often difficult to implement correctly and requires lots of memory space and computing power which in practice makes it very slow and/or expensive. If you use and knows what he wants to stay in the different language he can use a phrase dictionary where common phrases are stored in both languages. Manually, the user chooses the phrase most closely resembling what he wants to say and this phrase is then translated then into the other language. This works well for a small group of phrases but it requires that the phrases are looked for manually or input exactly as they are stored. This becomes cumbersome for large texts and also requires a great many phrases to be stored to receive a good accuracy for the translations.

Thus there exists a need for a translation engine that is easy to use, but gives accurate translations, but does not require a lot of CPU power or a large storage space.

### SUMMARY DISCLOSED EMBODIMENTS

On this background, it would be advantageous to provide a device that overcomes or at least reduces the drawbacks indicated above.

In one embodiment, this can be achieved having flexible phrases that have fields that can be filled-in.

In another embodiment, this can be achieved by providing a device comprising a memory and a processor, wherein said device is configured to identify a flexible phrase having at least one empty field, receive input corresponding to at least one field value and insert said at least one field value into said at least one empty filed thereby completing said flexible phrase.

By providing a phrase with empty fields that can be filled in a more flexible phrase is achieved which do not need to be exactly stated.

A device may be further configured to identify said flexible phrase from a first phrase in a first language wherein said flexible phrase is in a second language. The flexible phrase can advantageously be used for translating a phrase in one language into another language.

A device may be further configured to receive said first phrase through a keypad. This allows a user to input a phrase he wants to have translated into a device. The keypad can be both mechanical and virtual. It should also be noted that the input could also be done via Speech recognition (such as ASR), pen input (such as Hand writing recognition HWR) or optical recognition (such as OCR) using a scanner, a camera or an image stored in the device.

A device may be further configured to receive said first phrase through a data stream. This allows for translating one or more phrases that are being streamed to or by other means sent to the device.

A device may be further configured to receive said first phrase through a data collection stored in said memory. This allows for translating at least one phrase or a text body that is stored in said device or in a medium associated with the device such as magnetic or optical memory.

A device may be further configured to receive at least one field value through user input. This allows a user to complete the phrase and thus control what phrase he would like to have translated.

A device may be further configured to receive at least one field value by extracting said at least one field value from said first phrase. This allows for a more automated translation of at least one phrase without too much user interaction. This can be done by parsing for names and/or numbers as said at least one field value.

A device may be further configured to identify said flexible phrase by comparing said first phrase to at least one of a plurality of possible flexible phrases. This provides the device with a possibility to search for a flexible phrase in another language that matches a phrase received and that is to be translated, i.e. the first phrase.

A device may be further configured to perform a word by word comparison of said first phrase to said at least one of said plurality of possible flexible phrases. This is a very easy way to compare between a number of phrases and it is easy to implement. Naturally these possible flexible phrase would consist of a pair of phrases one for each language or the comparison would have little effect.

A device may be further configured to calculate a hit rate indicating how well a said first phrase compares to a possible flexible phrase. By calculating a hit rate the device will obtain a measurement of how good the comparison is and make it easier to identify the appropriate flexible phrase, especially if the comparison does not produce an exact match. The calculation can be weighted of similarities between words possibly also including synonyms and/or be weighted according to displacement of a word in one phrase to the corresponding word in another phrase.

A device may be further configured to identify a possible flexible phrase having a highest hit rate as said flexible phrase. If a total or exact match can not be found the device can choose the possible flexible phrase that has the highest hit rate which would be the one most resembling the sought for flexible phrase.

A device may be further configured to display on a display the possible phrases having highest hit rates for user identification of a possible flexible phrase as said flexible phrase. This allows a user to make the final decision as to which flexible phrase should be used if no exact match is found. Naturally the possible flexible phrases displayed are displayed in the same language as the first phrase is in as the user might otherwise not understand what phrases are being proposed.

A device may be further configured to regard at least one of said at least one possible flexible phrases as matches when said hit rate is above a threshold value. Using a threshold allows for both determining more exactly when a match is a match and also easier deciding which possible phrases should be displayed.

A device may be further configured to parse said first phrase to identify words being one of names or numbers and to ignore these identified words when comparing said first phrase to said at least one of said plurality of said possible flexible phrases. As a phrase could be uttered with many different names or numbers which still wouldn't affect the general underlying phrase memory space can be save by ignoring these words and thereby not having to store all phrases in all possible combinations.

A device may further have said plurality of possible flexible phrases stored in a dictionary in said memory. This allows for a fast access to said possible flexible phrases which enables a fast translation.

A device may be further configured to store said plurality of possible flexible phrases at least partially in one or more of a message inbox, a phonebook, a calendar or a game application stored in said memory. Using also other applications and their associated data can save storage space as some of the data in these applications may supplement the data in a specified dictionary which would in turn reduce the amount of redundant memory use.

A device may be further configured to download said plurality of possible flexible phrases from a remote memory. By allowing download of possible flexible phrases (and their paired phrase in another language) memory space at a local site can be spared.

A device may be further configured to store said plurality of possible flexible phrases in a remote memory at a remote location and said comparing is performed at said remote location. In doing this the device can make use of a potentially faster processor, a larger memory space and be freed to be used for other tasks while the translation is taking place.

A device as above may be a server.

A device such as above may be a mobile communications terminal.

In one embodiment the above may also be achieved by a method comprising identifying a flexible phrase having at least one empty field, receiving at least one field value and inserting said at least one field value into said at least one empty filed and thereby completing said flexible phrase.

This method and the methods below have the same or similar advantages as explained above for a device.

A method may further be used on a flexible phrase that corresponds to a first phrase in a first language wherein said flexible phrase is in a second language.

A method may further comprise receiving said first phrase through a keypad either virtual or mechanic. It should also be noted that the input could also be done via Speech recognition (such as ASR), pen input (such as Hand writing recognition HWR) or optical recognition (such as OCR) using a scanner, a camera or an image stored in the device.

A method may further comprise receiving said first phrase through a data stream.

A method may further comprise receiving said first phrase through a data collection stored in a memory.

An alternative is a method wherein receiving at least one field value comprises receiving said at least one field value through user input.

An alternative is a method wherein receiving at least one field value comprises extracting said at least one field value from said first phrase.

An alternative is a method wherein said extracting comprises parsing for names and/or numbers as said at least one field value.

An alternative is a method wherein identifying said flexible phrase comprises comparing said first phrase to at least one of a plurality of possible flexible phrases.

An alternative is a method wherein said comparing comprises a word by word comparison of said first phrase to said at least one of said plurality of possible flexible phrases.

An alternative is a method wherein said comparing comprising calculating a hit rate indicating how well a said first phrase compares to a possible flexible phrase.

An alternative is a method wherein said identifying comprises selecting a possible flexible phrase having a highest hit rate as said flexible phrase.

An alternative is a method wherein said identifying comprises displaying at least one possible phrase having a highest hit rate for user selection of a possible flexible phrase as said flexible phrase.

An alternative is a method wherein said identifying comprises regarding at least one of said at least one possible flexible phrase as matches when said at least one possible flexible phrase has a hit rate that is above a threshold value.

An alternative is a method wherein said comparing comprises parsing said first phrase to identify words being one of names or numbers and

ignoring said identified words when comparing said first phrase to said at least one of said plurality of said possible flexible phrases.

An alternative is a method wherein said comparing comprises fetching said plurality of possible flexible phrases from a local memory.

An alternative is a method wherein said comparing comprises fetching at least a part of said plurality of possible flexible phrases from one or more of a message inbox, a phonebook, a calendar or a game application stored in said local memory.

An alternative is a method wherein said comparing comprises fetching said plurality of possible flexible phrases from a remote memory.

An alternative is a method wherein said comparing comprises sending said first phrase to a remote location and comparing at said remote location.

In another embodiment the above can be achieved by providing a computer readable medium including at least computer program code for controlling a device comprising a memory and a display, said computer readable medium comprising software code for identifying a flexible phrase having at least one empty field, software code for receiving at least one field value and software code for inserting said at least one field value into said at least one empty field thereby completing said flexible phrase. By using program code such as this it would be possible to automate a device giving it the advantages as discussed above.

In a further embodiment, the above object is also achieved by providing a computer readable medium including at least computer program code for controlling a device to represent a flexible phrase having at least one empty field. This provides for a possibility of storing and using flexible phrases as described above in various terminals and also to send or transfer them between different devices.

A computer readable medium may further include computer program code for controlling a device to further represent a first phrase to said flexible phrase. This allows for storing, using or transferring of the first phrases on different devices.

A computer readable medium may further be a signal which enables the program code to be transferred more easily between different devices either through wired or wireless transmission.

In another embodiment the above is also achieved by providing a server arranged to receive a first phrase, identify a flexible phrase corresponding to said first phrase, return said flexible phrase, and wherein said flexible phrase comprises at least one empty field, which empty field is supplemented with a field value so as to form a complete flexible phrase.

In one embodiment, the above is also achieved by providing a system comprising a server as above and a terminal wherein said terminal is arranged to receive a first phrase,

upload said first phrase to said server and receive a flexible phrase corresponding to said first phrase from said server, and wherein said server is arranged to receive said first phrase from said terminal, identify said flexible phrase corresponding to said first phrase and return said flexible phrase to said terminal, and wherein said flexible phrase comprises at least one empty field, which empty field is supplemented with a field value so as to form a complete flexible phrase. This enables a quick and efficient translation in a terminal without setting too high demands on the terminal that may be low cost as the computationally heavy comparison and memory consuming storage of possible flexible phrases is performed at a larger server. This provides for cheaper terminals that can also execute other tasks while waiting for a translation to be done by the server.

An alternative system is a system wherein said terminal is arranged to provide said field value. This enables the terminal to provide the server with the field values as the server might not have knowledge of these from either user input or application data. This could be done through a user input

An alternative system is a system wherein said server is arranged to provide said field value. This makes it possible for the terminal to provide the fields without requiring user attention or consuming processor power from the terminal. This can be done by extracting said field value from said first phrase.

Another aspect of the disclosed embodiments is met by a method and a device as below.

The aspects of the disclosed embodiments provide a method comprising displaying a first phrase having at least one first field and a second phrase having at least one second field, wherein said first phrase is in one language and said second phrase is in another language and said at least one first field is associated to said at least one second field. This enables phrases that have corresponding phrases in other languages to be used in a very flexible and easy to use manner.

An alternative method further comprises updating said at least one first fields and at the same time updating said at least one second fields or updating said at least one second fields and at the same time updating said at least one first fields. By associating fields and updating associated fields at the same time here meaning either concurrently, simultaneously or followed shortly thereafter, it is easy for a user to fill in the values correctly as the associated fields in the first and second phrase might be in different order.

In a further alternative the fields are translated into the other language as they are updated in the associated field.

The above mentioned aspects and the above mentioned advantages are also met by and obtained by providing a device comprising a display and keypad configured to display a first phrase having at least one first field and to display a second phrase having at least one second field, wherein said first phrase is in one language and said second phrase is in another language and said at least one first field is associated to said at least one second field.

An alternative device is configured to update said at least one first fields and at the same time update said at least one second fields or

to update said at least one second fields and at the same time update said at least one first fields.

In a further alternative the fields are translated into the other language as they are updated in the associated field.

The above mentioned aspects and the above mentioned advantages are also met by and obtained by providing a user interface comprising a display and keypad configured to display a first phrase having at least one first field and to display a second phrase having at least one second field, wherein said first phrase is in one language and said second phrase is in another language and said at least one first field is associated to said at least one second field.

An alternative user interface is configured to update said at least one first fields and at the same time update said at least one second fields or

to update said at least one second fields and at the same time update said at least one first fields.

In a further alternative the fields are displayed as translated into the other language as they are updated in the associated field.

Further aspects, features, advantages and properties of the touchpad, method and computer readable medium according to the disclosed embodiments will become apparent from the detailed description.

### BRIEF DESCRIPTION OF THE DRAWINGS

In the following detailed portion of the present description, the disclosed embodiments will be explained in more detail with reference to the exemplary embodiments shown in the drawings, in which:

FIG. 1 is a plane front view of a device according to an embodiment,

FIG. 2 is a block diagram illustrating the general architecture of a device of FIG. 1 in accordance with the present application,

FIG. 3, is a block diagram of a computer code representation of a flexible phrase,

FIG. 4 are flow charts of a method according to an embodiment

FIG. 5 is a block diagram of a system according to an embodiment, and

FIG. 6 is a screen view according to an embodiment.

### DETAILED DESCRIPTION

In the following detailed description, the device, the method and the software product according to the teachings for this application in the form of a cellular/mobile phone will be described by the embodiments. It should be noted that although only a mobile phone is described the teachings of this application can also be used in any electronic device and preferably in portable electronic devices such as laptops, Personal digital assistants (PDAs), mobile communication terminals, electronic books and notepads and other electronic devices such as dictionaries and word books.

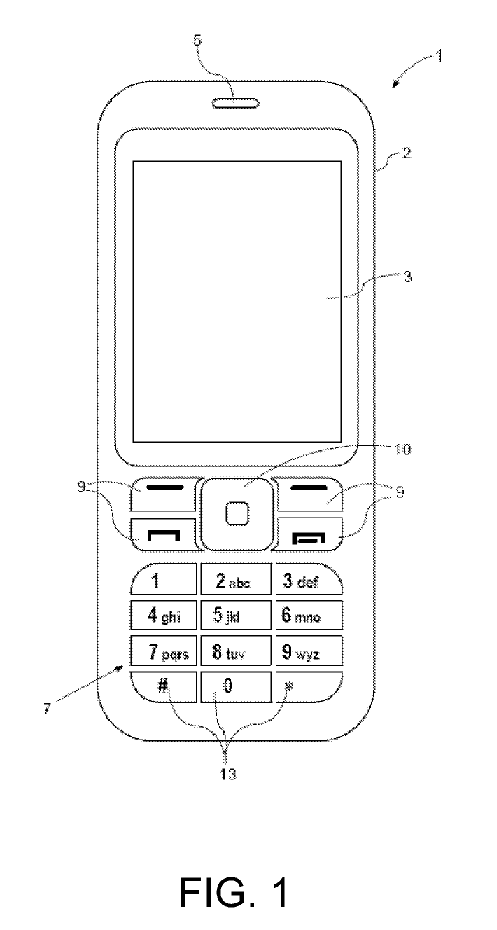

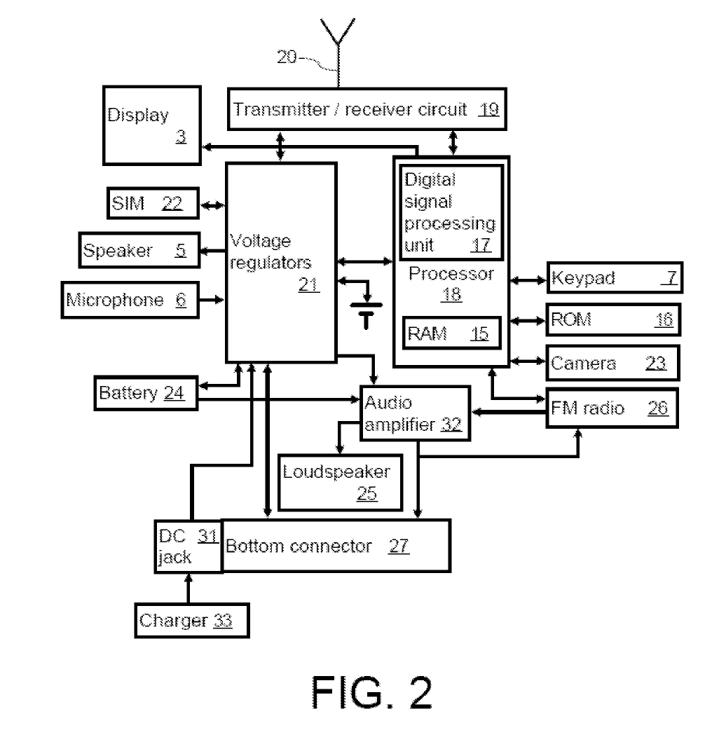

FIG. 1 illustrates an embodiment of a device in the form of a mobile telephone 1 by a front view. The mobile phone 1 comprises a user interface having a housing 2, a touch screen 3, a mechanical on/off button (not shown), a speaker 5 (reference number from FIG. 2), and a microphone 6 (reference number from FIG. 2). The phone 1 according to the first preferred embodiment is adapted for communication via a cellular network, such as the GSM 900/1800 MHz network, but could just as well be adapted for use with a Code Division Multiple Access (CDMA) network, a 3G network, or a TCP/IP-based network to cover a possible VoIP-network (e.g. via WLAN, WIMAX or similar) or a mix of VoIP and Cellular such as UMA (Universal Mobile Access) or any other suitable communication network.

Non vocal user input is mainly via a keypad 7 with discrete mechanical keys 9, 10, and 13. The screen 3 is typically made of an LCD with back lighting, such as a TFT matrix capable of displaying color images. The screen or display 3 can also be a touch screen. If said screen 3 is a touch screen it could be arranged to implement one or more of the mechanical keys 9, 10 or 13 or the keypad 7. It should also be noted that the input could also be done via Speech recognition (such as ASR), pen input (such as Hand writing recognition HWR) or optical recognition (such as OCR) using a scanner, a camera or an image stored in the device. The various input methods mentioned in this application, i.e. keypad, both virtual and mechanical, touch input, speech input, camera input or image analysis can be used for any of the different inputs mentioned in this application and in any combination. For example could a phrase be identified using an image (either stored in the device or taken with a camera) whereby the phrase is marked by a user and a field value could then be input using speech input. This would make the idea of this application more usable in many more situations and also adaptable to users with potential handicaps or in situations where use of fingers or hands is restricted. Another example is to speak the phrase and then add a field value by typing it which would enable input of a phrase and a field value that might be difficult to pronounce as is common with foreign languages. Using a camera would also enable input of characters that are not known to the user or possible to input using the keypad or touch pad on the device. One example of this is a Dutch user traveling in china and wanting to translate a phrase stating that he is staying at a certain hotel, but he can not pronounce the hotel name correctly, doesn't not know how to type it using pin yin so he takes a picture of the Hotel logo and identifies the character which is then used with the translated phrase. This last example is also a good example of when a server would be beneficial to identify said phrase and to construct the resulting phrase. This because a mobile communications terminal such as a phone might not be able to interpret the image taken by the camera, but the use would then simply send the image and the phrase to be translated to a server and the server, having greater resources, would then more likely be able to extract the character from the image and interpret it into a usable character code (such as the UNI code) and return the ready made translated flexible phrase.

The keys 9, 10 & 13 are used for, for example, dialing phone numbers or entering text The keypad 7 includes a four-way navigation plus select key 10 that is used for navigation and for selection of the function indicated in the label in the display screen 3 above the navigation key 10, the left soft key 9 and the right softkey 9 that are used for selecting function indicated in the respective label in the display screen 3 above the soft keys 9. Call handling is performed with an off hook key 11 for accepting incoming calls and for initiating a new call and the on hook key 12 is used for rejecting incoming calls and for ending ongoing calls. The labels above the soft keys 9 and above the navigation key 10 are adapted to the current mode of the phone.

The keypad 7 could also be a virtual keypad implemented on a touch screen which may be the same screen as screen 3.

FIG. 2 illustrates in a block diagram form the general architecture of a device 1 constructed in accordance with the present application. The processor 18 controls the operation of the terminal and has an integrated digital signal processor 17 and an integrated Random Access Memory (RAM) 15. The processor 18 controls the communication with the cellular network via the transmitter/receiver circuit 19 and an internal antenna 20. A microphone 6 coupled to the processor 18 via voltage regulators 21 transforms the user's speech into analogue signals, the analogue signals formed thereby are A/D converted in an A/D converter (not shown) before the speech is encoded in the Digital Signal Processor (DSP) 17 that is included in the processor 18. The encoded speech signal is transferred to the processor 18, which e.g. supports the GSM terminal software. The digital signal-processing unit 17 speech-decodes the signal, which is transferred from the processor 18 to the speaker 5 via a D/A converter (not shown). Various applications are stored in the memory 15 or 16 and are executed by the processor 18. Such applications can be message handling, web browsing, call handling, text editing and gaming. Other applications might be internal such as Hand Writing Recognition applications commonly referred to as HWR engines.

The processor 18 also forms the interface for some of the peripheral units of the device, including a Flash Read Only Memory (ROM) 16, the screen 3, the mechanical keypad 7, and an FM radio 26.

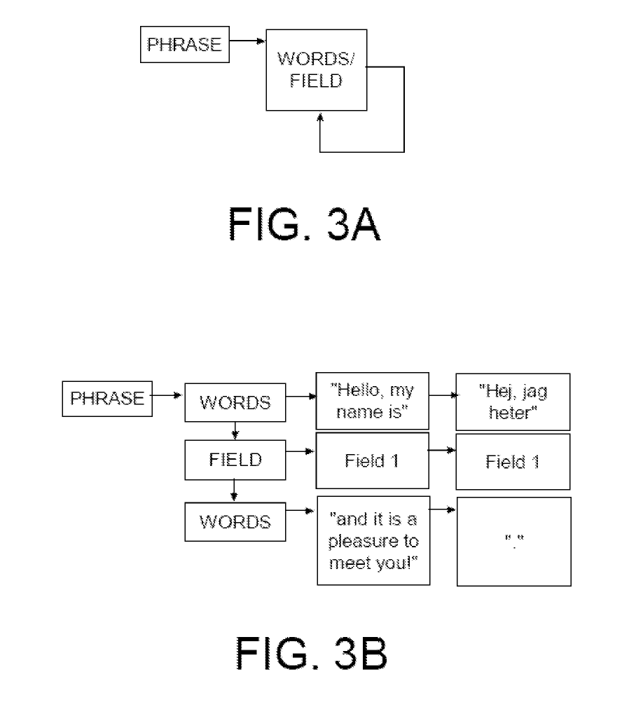

FIG. 3A shows an elementary computer code representation of a flexible phrase. It contains a number of blocks each consisting of either WORDS or NAMES. The WORDS are construed to be general strings that can contain any combination of known characters and numbers. The FIELD is a field in which a value is to be inserted to make the phrase complete. These values are commonly names, of either persons or places, and numbers or digits often representing times, dates, room numbers or house numbers and other data. In FIG. 3B an example is shown for the phrase “Hello, my name is John and it is a pleasure to meet you!” This phrase is divided into two WORDS and one FIELD. The two WORDS have the values “Hello, my name is” and “and it is a pleasure to meet you!” and the FIELD has a reference field 1 which will be used to assign it the value of a name. As a phrase “Hi, my name is John and it is a pleasure to meet you.” is input as a first phrase it is broken down into these blocks and a search is made for a matching flexible phrase. The flexible phrase shown is found as the closest match and the associated phrase in another language, in this case Swedish, is fetched. The field value of John is transferred over to the flexible phrase in the other language and the phrase is complete: “Hej, jag heter John.”. As can be seen the Swedish phrase is much shorter than the English as the Swedish language is sometimes shorter and more concise when it comes to greeting and courteous phrases. This is an example that a phrase might be differently expressed in different languages why a literal translation is not the best choice.

A device and a method will now be simultaneously described with reference to FIGS. 1, 2, 3 and 4 A-D below. In step 400 a device such as a mobile phone 1 identifies a flexible phrase. The device then receives a field value in step 470 and inserts this into the field of the flexible phrase identified in step 480.

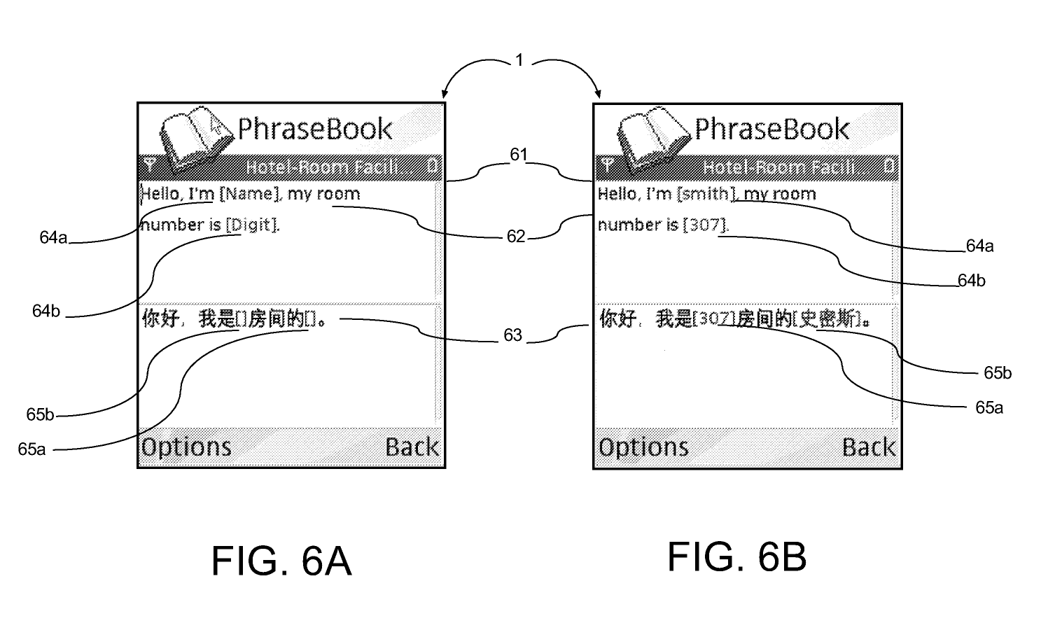

The identification step 400 can be executed in a number of ways. One example is shown in FIG. 6, a phrase library could be made available to a user and the user could then scroll through this library and choose a phrase that he wants to have translated, step 400. This phrase is then shown in both languages indicating which fields should be filled in. step 470. As the user fills in the fields in one language they are also filled in automatically in the corresponding position in the other language and the flexible phrase is completed.

The library could either be stored locally in the device or remotely.

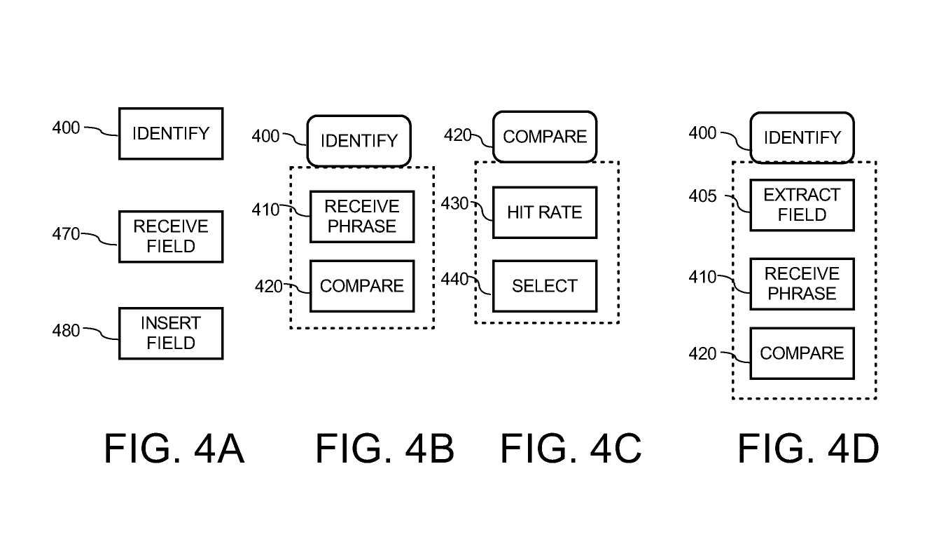

One alternative is to receive a starting phrase, or first phrase, in step 410 see FIG. 4B, and to compare this phrase to a plurality of possible flexible phrases in step 420. The plurality of possible flexible phrases can consist of a pair of phrases, one for each language if a translation from one language to another of the corresponding or start phase is sought. The first phrase is then compared to the possible flexible phrase in the same language. As a match is found the possible flexible phrase is identified as the flexible phrase or second phrase to be used. The first phrase can either be received in step 410 through the keypad 7 or from a data stream over the transceiver/receiver circuit 19 or from a data collection stored in a memory 15 or 16. The comparison in step 420 can be done either word by word or by using a semantic analysis. It should also be noted that the input could also be done via Speech recognition (such as ASR), pen input (such as Hand writing recognition HWR) or optical recognition (such as OCR) using a scanner, a camera or an image stored in the device.

It can also be done by letting the CPU 17 calculate a hit rate in step 430, see FIG. 4 C. This hit rate can either be calculated as the fraction of exactly matching words between the two phrases, by a weighted function of how close the words match each other taking into account synonyms for example or a weighted function relating to how far away from each other the two words are in the two phrases. The hit rate can then be used to decide and select which flexible phrase matches in step 440. Either a possible flexible phrase can be selected to be the identified flexible phrase directly if a high hit rate is obtained, in the order of 97, 98, 99 or 100%, or a number of possible flexible phrases all having high hit rates can be displayed on the display 3 so that a user can choose the phrase most corresponding to the start or first phrase. This set of possible flexible phrases can be chosen as the ones having a hit rate above a certain threshold value. Alternatively the first possible flexible phrase getting a hit rate above the threshold is chosen. In the first alternative a lower hit rate threshold could be used, for example 60, 70, 80, 90 or 95% or any value there in between. And in the second alternative a higher threshold value should be chosen, for example 97, 98, 99 or 100% or any value there in between. It should be noted that these two selection alternatives can be used simultaneously wherein if no possible flexible phrase can be found to have a hit rate over say 99% the ones having hit rates above say 80% are displayed.

Before the comparison is made in step 420, see FIG. 4 D, the start or first phrase could be searched for any words resembling a field and extracting these in step 450. This could be done by parsing for names and/or numbers. Having found these words they could be ignored or simply made blank in the comparison or assumed to be a field value requiring to be matched by an equal number of fields in the possible flexible phrases.

It should be noted that the plurality of possible flexible phrases could both be stored locally in the device or remotely. If stored locally it could both be stored in a special dictionary or parts of it could be stored in data storages belonging to various applications such as the message in and outboxes, the phonebook, games and calendar applications as these applications often have long text strings containing many useful phrases. This would help save storage space as some phrases would not need to be stored twice in the same device.

When the plurality of possible flexible phrases is stored remotely the comparison could also be done remotely. This would save time and bandwidth as only the first phrase and the resulting flexible phrase would be needed to be communicated. The device could then have a processor 17 of lower processing power, a smaller memory space 15 and 16 and also be left to perform other tasks while the comparison is taking place.

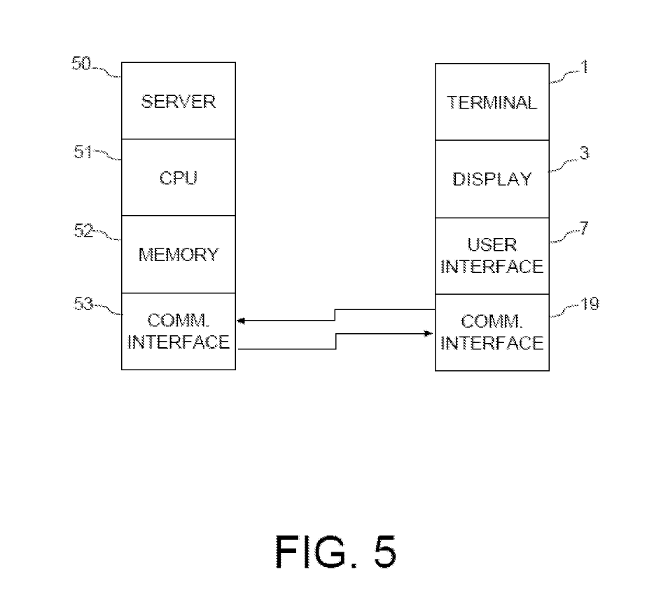

FIG. 5 shows such a system where a terminal 1 has a display 3 and a user interface 7 preferably in the form of a keypad. It should also be noted that the input could also be done via Speech recognition (such as ASR), pen input (such as Hand writing recognition HWR) or optical recognition (such as OCR) using a scanner, a camera or an image stored in the device. A user types in a first phrase using the keypad 7 and the terminal 1 sends the first phrase via a communication interface 19 to the server. The server receives the first phrase through its communication interface 53 and compares it as discussed above to a plurality of possible flexible phrases stored in a memory 52. As a match is found, the second phrase (or flexible phrase) is transmitted back to the terminal and displayed to the user on the display 3. As described above the extraction of field values can either be done on the terminal side and sending the first phrase with stipulated fields. This can either be done by extracting the fields using a technique as described above or by user input. Alternatively the fields can be extracted in the server 50. Either through an extraction technique as described above or by user input. It is possible that there is an operator working on the server side that identifies the fields. An operator can either be a human technician, a service operator or an automated process.

It should be noted that the first phrase and the start phrase are the same according to the teachings of this application. It should also be noted that the second phrase and the flexible phrase are also the same according to the teachings of this application.

Another embodiment will now be described with reference to FIG. 6. In FIG. 6 A a screen shot 61 of display 3 of a mobile phone is shown. A first phrase 62, starting or corresponding, is shown on the top level in one language, English, and a flexible phrase 63 corresponding to this is shown in a lower level of the display in a different language, Chinese. The first phrase 62 has two fields, 64a and 64b. These can be referred to as first fields as they belong to the first phrase. In this example they are marked with a tag describing an appropriate value to be assigned by a user. For field 64a it is [Name] and for field 64b it is [Digit]. The flexible phrase 63 that corresponds to this first phrase 62 also has fields marked 65a and 65b. These can be referred to as second fields as they belong to the second phrase. For this particular phrase the two corresponding fields are not in the same order as in the first phrase, but they are still associated 64a with 65a and 64b with 65b respectively. A user marks one field in either of the first phrase 62 or the corresponding flexible phrase 63 or second phrase 63 by touch input or by navigating to it using the keypad 7. Then the user inputs values in the first field through the keypad 7, that can be mechanical or virtual as described above, and continues with the next. The associated fields in the other phrase are updated at the same time by the mobile phone and the user now has the complete phrase in both English and Chinese as can be seen in FIG. 6 B. As can be seen one field 65b has been translated into Chinese. The mobile phone can be instructed to replace field values with corresponding translated values if such exist. Digits can have translations when going from Asian or Latin text to Arabic, the Arabic digit signs being different from the Latin even if they are denoted as being Arabic. Names do not always have to be translated and especially not if a match can not be found. However, the fields may relate to other words such as in the phrase: “Could you please reserve the time [DIGIT] for our [WORD].” Here the field [WORD] could have any value of the following: “meeting”, “lunch”, “date”, “dinner”, “teleconference”, “chess game” or any other of a great many possibilities. Here the field value should be translated as otherwise it would make no sense.

The phrase can now be used for its intended purpose, whether it is to be spoken, written down, stored or used by some other application.

The updating of the associated fields is described above to be done at the same time. This could be done so that they are either updated simultaneously character by character or after a field has been accepted or finished. In other words the updating can be either simultaneously, concurrently or shortly thereafter.

It should be noted that before arriving at the screen shot 61 of FIG. 6A a user could have searched a library or dictionary, either remotely or locally, to find or identify the phrase wanted. This dictionary could be alphabetically categorized and/or categorized by subject to make the search easier.

One other possibility is that the user simply inputs what he wants to say and the device finds a phrase that resembles what the user input and displays this first phrase 62 and/or the corresponding flexible phrase 63.

Although the teaching of this application has been described in detail for purpose of illustration, it is understood that such detail is solely for that purpose, and variations can be made therein by those skilled in the art without departing from the scope of the teaching of this application.

For example, although the teaching of this application has been described in terms of a mobile phone, it should be appreciated that the disclosed embodiments may also be applied to other types of electronic devices, such as cameras, video recorders, music players, palmtop computers, PDAs, electronic devices such as dictionaries and word books and the like. It should also be noted that there are many alternative ways of implementing the methods and apparatuses of the teaching of this application. For example, a user might want to input the Icelandic version of “Aye Caramba! Johnny fell down in a glacier!” and add it to a video clip showing a person climbing out of a glacier.

The term “comprising” as used in the claims does not exclude other elements or steps. The term “a” or “an” as used in the claims does not exclude a plurality. The single processor or other unit may fulfill the functions of several means recited in the claims.

What is claimed is:

1. A device comprising a memory and a processor, wherein said device is configured to
identify a flexible phrase having at least one empty field,
receive input corresponding to at least one field value and
insert said at least one field value into said at least one empty field thereby completing said flexible phrase.

2. A device according to claim 1, wherein said device is further configured to identify said flexible phrase from a first phrase in a first language wherein said flexible phrase is in a second language.

3. A device according to claim 2 further configured to translate said at least one field value into said second language before inserting it in said flexible phrase.

4. A device according to claim 1, wherein said device is further configured to receive said first phrase through one or more of the following: speech recognition, pen input unit, optical recognition and a keypad.

5. A device according to claim 1, wherein said device is further configured to receive said first phrase through a data stream or a data collection stored in said memory.

6. A device according to claim 1, wherein said device is further configured to receive at least one field value through user input or by extracting said at least one field value from said first phrase.

7. A device according to claim 6, wherein said extracting comprises parsing for names and/or numbers as said at least one field value.

8. A device according to claim 1, wherein said device is further configured to identify said flexible phrase by comparing said first phrase to at least one of a plurality of possible flexible phrases.

9. A device according to claim 8, wherein said device is further configured to calculate a hit rate indicating how well a said first phrase compares to a possible flexible phrase.

10. A device according to claim 9, wherein said device is further configured to display on a display the possible phrases having highest hit rates for user identification of a possible flexible phrase as said flexible phrase.

11. A device according to claim 9, wherein said device is further configured to regard at least one of said at least one possible flexible phrases as matches when said hit rate is above a threshold value.

12. A device according to claim 8, wherein said device is further configured to parse said first phrase to identify words being one of names or numbers and
to ignore these identified words when comparing said first phrase to said at least one of said plurality of said possible flexible phrases.

13. A device according to claim 8, wherein said plurality of possible flexible phrases is stored in a dictionary in said memory or wherein said device is further configured to download said plurality of possible flexible phrases from a remote memory.

14. A device according to claim 8, wherein said plurality of possible flexible phrases is stored in a remote memory at a remote location and said comparing is performed at said remote location.

15. A device according to claim 1 wherein said device is a mobile communication terminal.

16. A device according to claim 1 wherein said device is a server.

17. A method comprising:
identifying a flexible phrase having at least one empty field,
receiving at least one field value and
inserting this at least one field value into said at least one empty filed and thereby
completing said flexible phrase.

18. A method according to claim 17, wherein said flexible phrase corresponds to a first phrase in a first language wherein said flexible phrase is in a second language.

19. A method according to claim 18 further comprising translating said at least one field value into said second language before inserting it in said flexible phrase.

20. A method according to claim 18, further comprising receiving said first phrase through an input, through a data stream or from a data collection stored in a memory.

21. A method according to claim 17, wherein receiving at least one field value comprises receiving said at least one field value through user input or extracting said at least one field value from said first phrase.

22. A method according to claim 21, wherein said extracting comprises parsing for names and/or numbers as said at least one field value.

23. A method according to claim 17, wherein identifying said flexible phrase comprises comparing said first phrase to at least one of a plurality of possible flexible phrases.

24. A method according to claim 23, wherein said comparing comprises a word by word comparison of said first phrase to said at least one of said plurality of possible flexible phrases.

25. A method according to claim 17, wherein said comparing comprising calculating a hit rate indicating how well a said first phrase compares to a possible flexible phrase.

26. A method according to claim 25, wherein said identifying comprises regarding at least one of said at least one possible flexible phrase as matches when said at least one possible flexible phrase has a hit rate that is above a threshold value.

27. A method according to claim 23, wherein said comparing comprises parsing said first phrase to identify words being one of names or numbers and
ignoring said identified words when comparing said first phrase to said at least one of said plurality of said possible flexible phrases.

28. A method according to claim 23, wherein said comparing comprises fetching said plurality of possible flexible phrases from a local memory or from a remote memory.

29. A method according to claim 23, wherein said comparing comprises sending said first phrase to a remote location and comparing at said remote location.

30. A computer readable medium including at least computer program code for controlling a device comprising a memory and a display, said computer readable medium comprising:
software code for identifying a flexible phrase having at least one empty field,
software code for receiving at least one field value and
software code for inserting said at least one field value into said at least one empty field thereby completing said flexible phrase.

31. A computer readable medium including at least computer program code for controlling a device to represent a flexible phrase having at least one empty field.

32. A computer readable medium according to claim 31 further including computer program code for controlling a device to further represent a first phrase to said flexible phrase.

33. A computer readable medium according to claim 31 wherein said medium is a signal.

34. A server arranged to:
receive a first phrase,
identify a flexible phrase corresponding to said first phrase,
return said flexible phrase,
and wherein said flexible phrase comprises at least one empty field, which empty field is supplemented with a field value so as to form a complete flexible phrase.

35. A system comprising a server according to claim 34 and a terminal wherein said terminal is arranged to:
receive a first phrase,
upload said first phrase to said server
and receive a flexible phrase corresponding to said first phrase from said server, and wherein said server is arranged to:
receive said first phrase from said terminal and
return said flexible phrase to said terminal.

36. A system according to claim 35 wherein said terminal is arranged to provide said field value.

37. A system according to claim 35 or a server according to claim 32 wherein said server is arranged to provide said field value.

38. A method comprising displaying a first phrase having at least one first field and a second phrase having at least one second field, wherein said first phrase is in one language and said second phrase is in another language and said at least one first field is associated to said at least one second field.

39. A method according to claim 38 further comprising updating said at least one first fields and at the same time updating said at least one second fields or updating said at least one second fields and at the same time updating said at least one first fields.

40. A method according to claim 39 wherein said updating of said at least one first fields comprises translating said at least one first fields into said second language or wherein said updating of said at least one second fields comprises translating said at least one second fields into said first language.

41. A device comprising a display and an input, wherein said device is configured to_display a first phrase having at least one first field and to display a second phrase having at least one second field, wherein said first phrase is in one language and said second phrase is in another language and said at least one first field is associated to said at least one second field.

42. A device according to claim 41 further configured to update said at least one first fields and at the same time update said at least one second fields or
to update said at least one second fields and at the same time update said at least one first fields.

43. A device according to claim 41 further configured to translate said at least one first fields into said second language when updating said at least one first fields and to translate said at least one second fields into said first language when updating said at least one second fields.

44. A user interface comprising a display and an input, wherein said user interface is configured to_display a first phrase having at least one first field and to display a second phrase having at least one second field, wherein said first phrase is in one language and said second phrase is in another language and said at least one first field is associated to said at least one second field.

45. A user interface according to claim 44 further configured to update said at least one first fields and at the same time update said at least one second fields or
to update said at least one second fields and at the same time update said at least one first fields.
